(19) United States
(12) Patent Application Publication
(10) Pub. No.: US 2024/0147924 A1
(43) Pub. Date: May 9, 2024

(54) PLANT CULTIVATION SYSTEM

(71) Applicants: Andrew Peck, Queen Creek, AZ (US); Kent Hamilton, Mesa, AZ (US)

(72) Inventors: Andrew Peck, Queen Creek, AZ (US); Kent Hamilton, Mesa, AZ (US)

(21) Appl. No.: 18/484,502

(22) Filed: Oct. 11, 2023

Related U.S. Application Data
(60) Provisional application No. 63/382,586, filed on Nov. 7, 2022.

(51) Int. Cl. A01G 31/06

(52) U.S. Cl. CPC A01G 31/06; A01G 2031/006

(57) ABSTRACT

An integrated plant cultivation system for enhancing plant cultivation efficiency in controlled environments or agricultural facilities may incorporate a growth-inducing light source. The system may include a versatile rack assembly for multi-level plant cultivation with boxes on each level. The boxes may contain incubation chambers for plant growth. An irrigation system may connect to the incubation chambers, providing water and nutrient solutions tailored to each chamber's unique nutrition needs. The system may also include a drainage management system to recover excess water and nutrients, promoting sustainability. In addition, the system may further include a ventilation sub-system configured to provide ideal atmospheric conditions within the incubation chambers. The system may further comprise a controller configured to oversee the growth-inducing light source and environmental parameters in each chamber, optimizing plant development according to their specific growth stages and requirements.

### BACKGROUND OF THE TECHNOLOGY

“Vertical-farming” methods for the cultivation of plants have been developed in which plants are cultivated above each other on multiple vertical levels, providing particularly efficient cultivation and high yields per surface area of land. Such plants are generally cultivated in plant containers, for example individual containers, which are placed on a support structure which provides the multiple vertical levels. A set of mutually connected plant containers can be placed in a tray on the support structure for easier combined handling of multiple containers. In vertical farming, growing conditions for the plants are generally influenced by controlled and/or active means, e.g., for influencing irrigation, drainage, nutrition, light, temperature, humidity, and atmospheric composition.

As farmers strive to increase their plant production per area, properly managing the growing conditions for the plants becomes increasingly challenging. Conventional vertical-farming systems position the plants close together, so that a relatively dense foliage is formed among the plants, which may become denser as the plants grow. Such a dense foliage has been found to inhibit good control of several growing conditions, such as light, temperature, humidity, and atmospheric conditions. Specifically, the dense foliage inhibits good ventilation and airflow as the foliage effectively forms a barrier layer which deflects and/or dampens such flow, which disadvantageously inhibits the exchange of gasses, water and energy between the plants and their environment. Also, conventional vertical-farming systems to do not adequately protect the plants from various contaminants, such as viruses, bacteria, and fungi.

Accordingly, what is needed is a vertical-farming system and/or method for plant cultivation that maximizes plant yield rates, quantity, and quality, and eliminates or significantly reduces the presence of contaminants.

### SUMMARY OF THE TECHNOLOGY

An integrated plant cultivation system for enhancing plant cultivation efficiency in controlled environments or agricultural facilities may incorporate a growth-inducing light source. The system may comprise a versatile rack assembly for multi-level plant cultivation with boxes on each level. The boxes may contain incubation chambers for plant growth. An irrigation system may connect to the incubation chambers, providing water and nutrient solutions tailored to each chamber's unique nutrition needs. The system may also comprise a drainage management system to recover excess water and nutrients, promoting sustainability. In addition, the system may further comprise a ventilation sub-system configured to provide ideal atmospheric conditions within the incubation chambers. The system may further comprise a controller configured to oversee the growth-inducing light source and environmental parameters in each chamber, optimizing plant development according to their specific growth stages and requirements.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is a block diagram of an integrated plant cultivation system in accordance with an embodiment of the present technology;

FIG. 2 representatively illustrates a top view of a multi-level rack assembly of an integrated plant cultivation system in accordance with an embodiment of the present technology;

FIG. 3A representatively illustrates a perspective view of a box and incubation chambers of an integrated plant cultivation system in accordance with an embodiment of the present technology;

FIG. 3B representatively illustrates a perspective view of a box and incubation chambers of an integrated plant cultivation system in accordance with an embodiment of the present technology;

FIG. 3C representatively illustrates a perspective view of a box an incubation chambers of an integrated plant cultivation system in accordance with an embodiment of the present technology;

FIG. 3D representatively illustrates a perspective view of an incubation chamber of an integrated plant cultivation system in accordance with an embodiment of the present technology;

FIG. 3E representatively illustrates a perspective view of an incubation chamber of an integrated plant cultivation system in accordance with an embodiment of the present technology;

FIG. 3F representatively illustrates a perspective view of an incubation chamber of an integrated plant cultivation system in accordance with an embodiment of the present technology;

FIG. 3G representatively illustrates a side view of an incubation chamber of an integrated plant cultivation system in accordance with an embodiment of the present technology;

FIG. 4 representatively illustrates a perspective view of a first level and a second level of a multi-level rack assembly in accordance with an embodiment of the present technology;

FIG. 5 representatively illustrates a perspective view of a box mounted on a tray in accordance with an embodiment of the present technology;

FIG. 6 representatively illustrates a perspective view of a feedwater diffuser head of an integrated plant cultivation system in accordance with an embodiment of the present technology;

FIG. 7 representatively illustrates an irrigation system of an integrated plant cultivation system in accordance with an embodiment of the present technology;

FIG. 8 is a block and flow diagram of a water management system of an integrated plant cultivation system in accordance with an embodiment of the present technology;

FIG. 9A is a block and flow diagram of a water treatment process for an integrated plant cultivation system in accordance with an embodiment of the present technology; and

FIG. 9B is a block and flow diagram of a water-cooling process for the water treatment process shown in FIG. 9A.

### DETAILED DESCRIPTION OF EXEMPLARY EMBODIMENTS

The present technology may be described herein in terms of functional components. Such functional components may be realized by any number of components configured to perform the specified functions and achieve the various results. For example, the present technology may employ various controllers, processors, boxes, incubation chambers, trays, support structures, rack assemblies, irrigation systems, water tanks, reclaim tanks, piping, tubing, conduits, feed systems, ventilation systems, light sources, sterilizers, and the like, which may carry out a variety of functions. In addition, the present technology may be practiced in conjunction with any number of controlled environments or agricultural facilities, and the plant cultivation system described herein is merely one exemplary application for the technology.

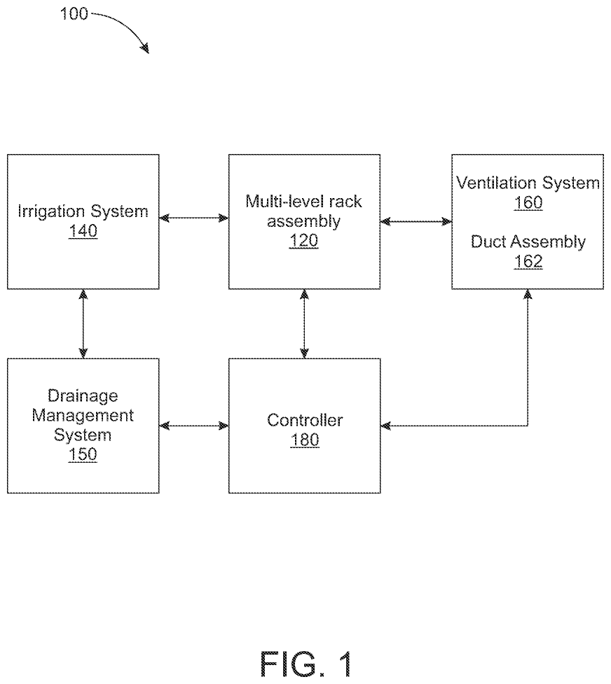

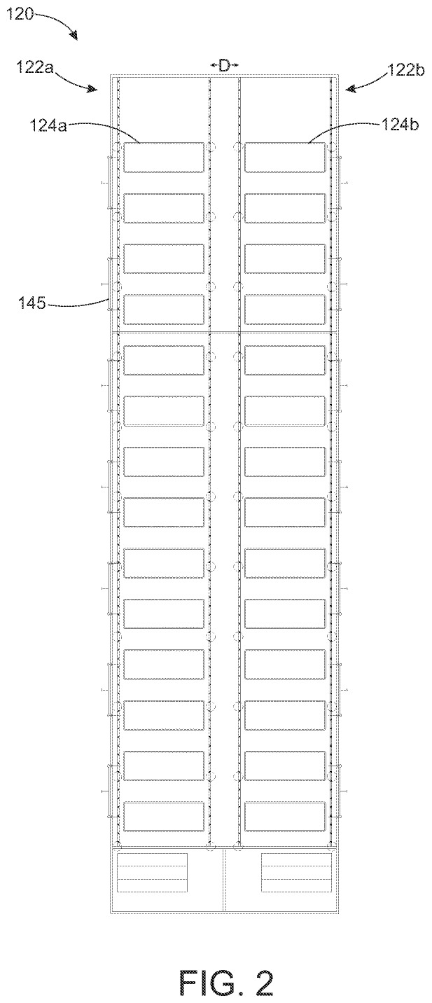

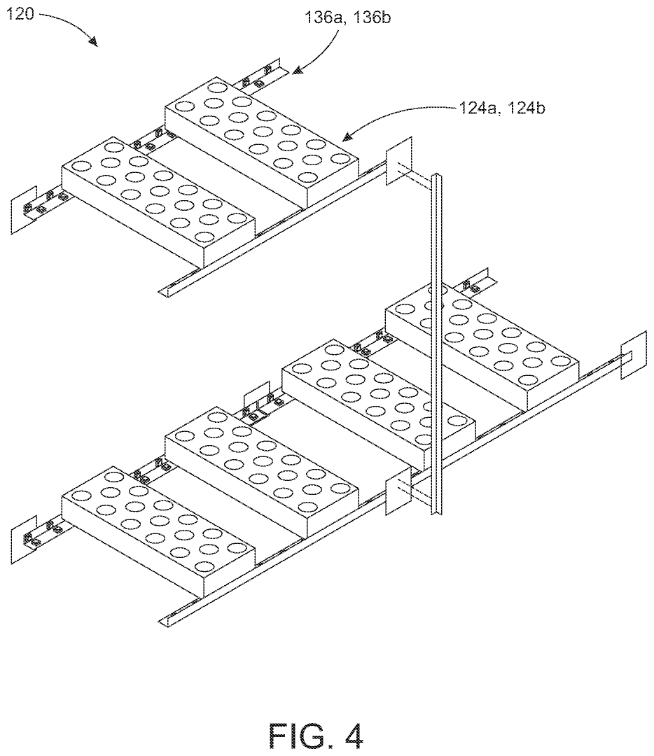

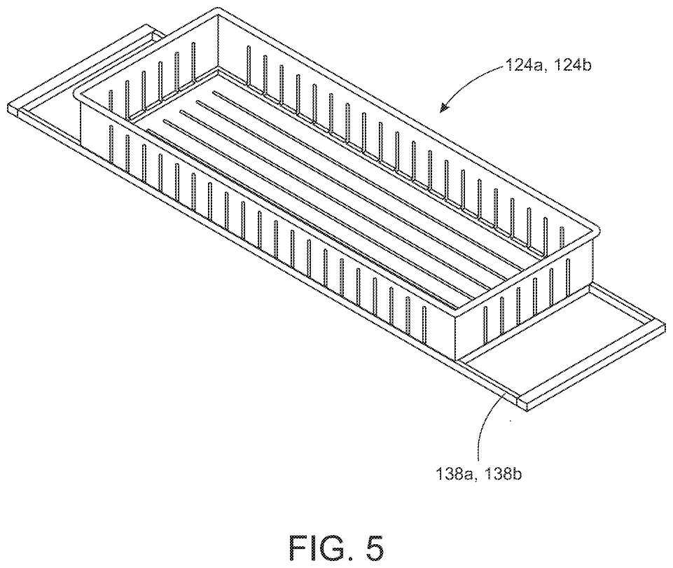

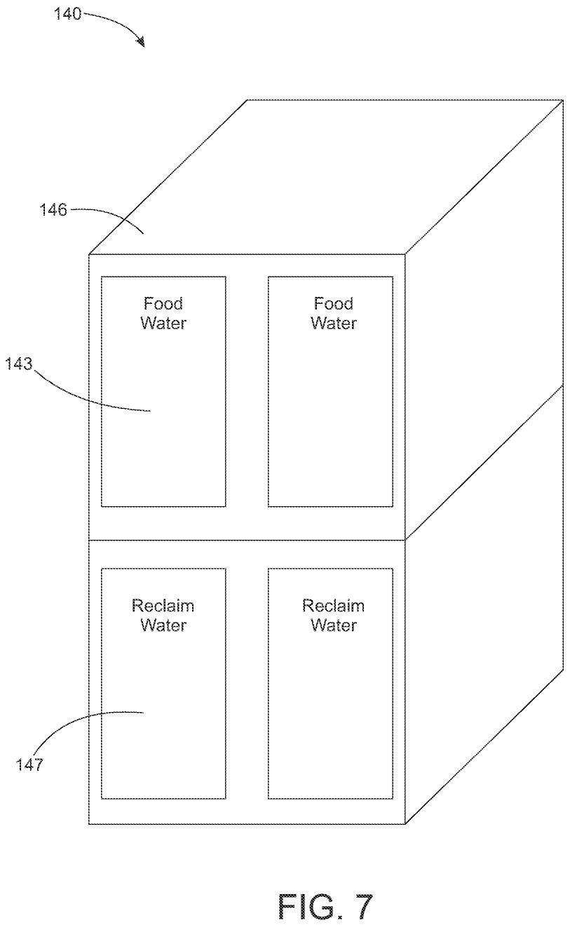

According to various embodiments, and referring now to FIGS. 1-9, an integrated plant cultivation system 100 for use in a controlled environment (e.g., agricultural facility) that maximizes plant yield rates, quantity, and quality for a given footprint of area in the agricultural facility may comprise a multi-level rack assembly 120, an irrigation system 140, a ventilation system 160, and a controller 180. As generally used herein, a “plant” includes, but is not limited to, any type of plant, such as cannabis, hemp, and the like.

In one embodiment, the multi-level rack assembly 120 may comprise a first multi-level rack 122a positioned adjacent a second multi-level rack 122b at a distance D therefrom to form a walking path between the first multi-level rack 122a and the second multi-level rack 122b. Each level of the first multi-level rack 122a may comprise a first plurality of open-ended containers or boxes 124a, where each of the first plurality of boxes 124a may comprise a first plurality of incubation chambers 126a disposed therein. Similarly, each level of the second multi-level rack 122b may comprise a second plurality of boxes 124b, where each of the second plurality of boxes 124b may comprise a second plurality of incubation chambers 126b disposed therein. Each box 124a, 124b may be manufactured from any suitable material, such as plastic or the like.

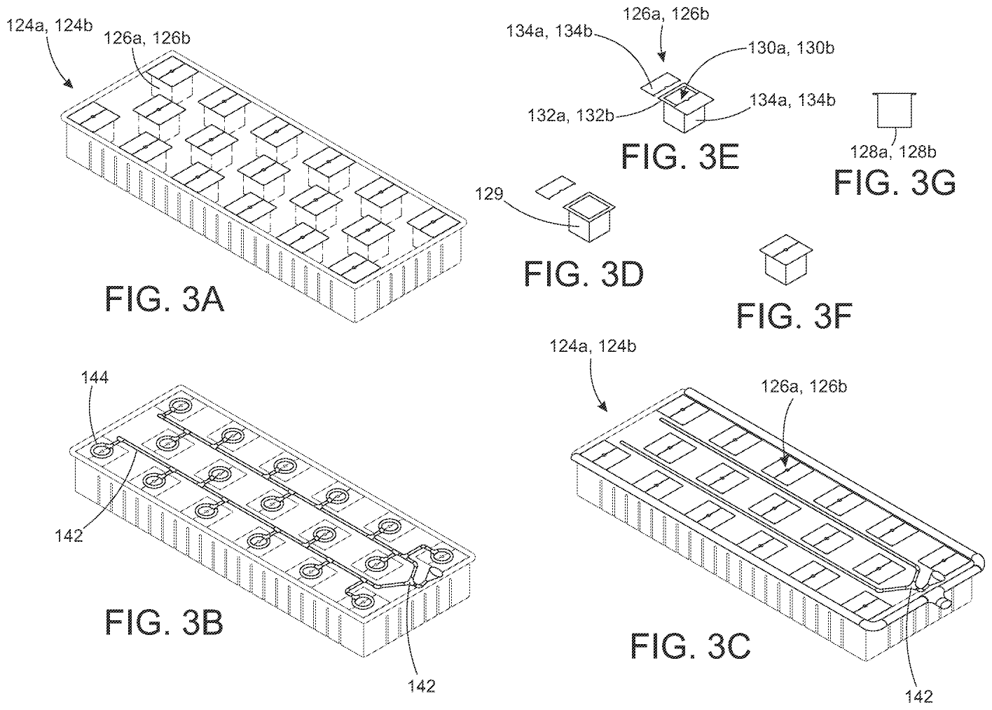

Referring now to FIG. 3, each incubation chamber 126a, 126b may comprise a sensor 129 configured to monitor the environmental conditions and provide real-time data to the controller 180 for regulation of growth of the plants. Each of the first plurality of incubation chambers 126a may comprise any suitable shape, such as a cubic-shaped body or a rectangular-shaped body for containing a plant therein. In one embodiment, each incubation chamber 126a may comprise a first base 128a, a first open end 130a opposite the first base 128a where the first open end 130a may terminate in a first peripheral edge 132a, and a first sidewall 134a disposed around an outer perimeter of the first base 128a and extending from the first base 128a to the first peripheral edge 132a. Each incubation chamber 126a may further comprise a first cover 134a mounted on the first peripheral edge 132a and configured to move between an open position and a closed position such that the incubation chamber 126a may be substantially closed when the first cover 134a is in the closed position. In one embodiment, each cover 134a may be configured to slide between an open position and a closed position.

Similarly, each of the second plurality of incubation chambers 126b may comprise any suitable shape, such as a cubic-shaped body or a rectangular-shaped for containing the plants therein. In one embodiment, each incubation chamber 126b may comprise a second base 128b, a second open end 130b opposite the second base 128b where the second open end 130b may terminate in a second peripheral edge 132b, and a second sidewall 134b disposed around an outer perimeter of the second base 128b and extending from the second base 128b to the second peripheral edge 132b. Each incubation chamber 126b may further comprise a second cover 134b mounted on the second peripheral edge 132b and configured to move between an open position and a closed position such that the incubation chamber 126b may be substantially closed when the second cover 134b is in the closed position. In one embodiment, each cover 134b may be configured to slide between an open position and a closed position.

Referring now to FIGS. 3-5, the first multi-level rack 122a may comprise stackable and interconnectable units. The units may be scalable and/or modular and may form levels of the first multi-level rack 122a. In one embodiment, each level of the first multi-level rack 122a may comprise a first pair of parallel spaced angle bars 136a spanning longitudinally between a first drying room and a first space of the controlled environment. The first pair of parallel spaced angle bars 136a may each comprise two “legs” that are perpendicular to each other. In addition, each level of the first multi-level rack 122a may comprise a first plurality of frames or support structures 138a spaced apart from each other and extending between the first pair of parallel spaced angle bars 136a. Each support structure 138a may be of any suitable size or shape as to allow one of the first plurality of boxes 124a to be mounted thereon. Each support structure 138a may be coupled or attached to the “legs” of the first pair of spaced angle bars 136a.

Similarly, the second multi-level rack 122b may comprise stackable and interconnectable units. The units may be scalable and/or modular and may form levels of the second multi-level rack 122b. In one embodiment, each level of the second multi-level rack 122b may comprise a second pair of parallel spaced angle bars 136b spanning longitudinally between a second drying room and a second space of the controlled environment. The second pair of parallel spaced angle bars 136b may each comprise two “legs” that are perpendicular to each other. In addition, each level of the second multi-level rack 122b may comprise a second plurality of frames or support structures 138b spaced apart from each other and extending between the second pair of parallel spaced angle bars 136b. Each support structure 138b may be of any suitable size or shape as to allow one of the second plurality of boxes 124b to be mounted thereon. Each support structure 138b may be coupled or attached to the “legs” of the second pair of spaced angle bars 136b.

The first multi-level rack 122a and the second multi-level rack 122b may each comprise a vertically adjustable height such that the distance between the growth inducing light source and the plants contained in the first plurality of incubation chambers 126a and the second plurality of incubation chambers 126b, respectively, may be adjusted based on the maturity of the plants in order to optimize plant growth. Each multi-level rack 122a, 122b may comprise one or more locking components (not shown) and a plurality of height adjustable slots (not shown) to enable an operator of the system 100 to manually adjust the vertical height of the first and second multi-level racks 122a, 122b. Alternatively, instead of manually adjusting the height of the first and second multi-level racks 122a, 122b, the height may be adjusted electronically via a motor (not shown) which may be operably controlled by the controller 180. The height of the first multi-level rack 122a and the second multi-level rack 122b may, however, each be adjusted in any suitable manner.

The irrigation system 140 may comprise a feed system 141 configured to supply water and/or nutrient solution from a water or nutrient tank 143 to the first plurality of incubation chambers 126a and the second plurality of incubation chambers 126b. The irrigation system 140 may comprise one or more conduits, such as piping or tubing 142, and one or more pumps (not shown) for moving the water and/or nutrient solution from the water or nutrient tank 143 to the first plurality of incubation chambers 126a and the second plurality of incubation chambers 126b. The piping or tubing 142 of the feed system 141 may be independently routed to each incubation chamber 126a, 126b such that each incubation chamber 126a, 126b may be provided with its own feed cycle and/or nutrition scheme. The irrigation system 140 may also comprise one or more conduits, such as piping or tubing 145, and one or more pumps (not shown) that operate in conjunction with each other to reclaim and recycle drainage that may result from overwatering or overfeeding the plants.

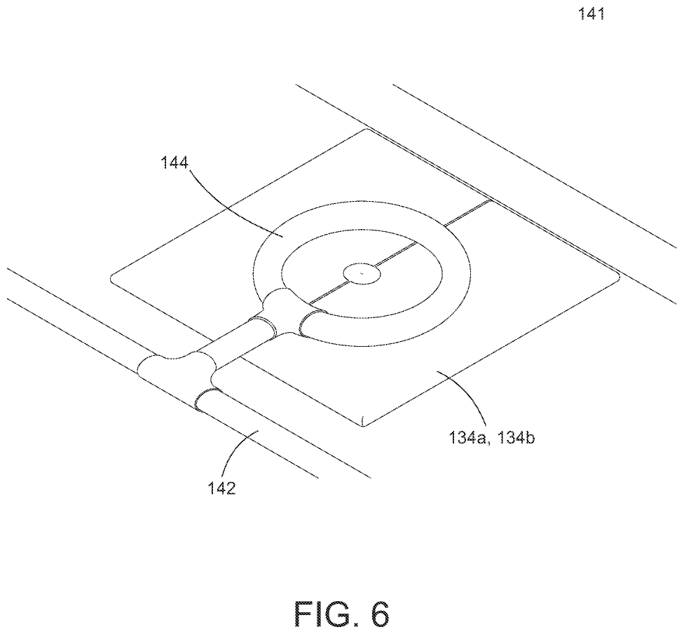

In one embodiment, the piping or tubing 142 of the feed system 141 may be coupled to a plurality of “feedwater diffuser heads” 144, such as shown in FIG. 6. The plurality of feedwater diffuser heads 144 may operate in conjunction with a misting apparatus (not shown) for dispersing a controlled amount of water and/or nutrient solution over the plants. Specifically, each feedwater diffuser head 144 may be positioned over the first cover 134a of one of the first plurality of incubation chambers 126a or the second cover 134b of one of the second plurality of incubation chambers 126b. Because plants like cannabis have different nutritional demands depending on their stage of maturity, independently routing the piping, or tubing 142 of the feed system 141 to the first plurality of incubation chambers 126a and the second plurality of incubation chambers 126b permits an operator of the system 100 to customize the feed cycle and/or nutrition scheme according to each plants maturity, thereby optimizing the growth rate of the plants. Each feedwater diffuser head 144 may comprise an annular ring-shaped body, which may aid in effectively circulating or misting a water and/or nutrient solution over the entire plant contained in the first and second plurality of incubation chambers 126a, 126b.

The irrigation system 140 may be connected to a drainage management system 150. The drainage management system 150 may comprise a housing 146 for containing the water or nutrient tank 144 and a reclaim tank 147 therein. In one embodiment, the housing 146 may comprise stackable and interconnectable units. In an alternative embodiment, the housing 146 may comprise a single unit with multiple levels such that the water tank 143 may stacked on top of the reclaim tank 147, or vice versa. Because the water tank 143 and the reclaim tank 147 may be stackable, the irrigation system 140 may reduce carbon emissions and/or the carbon footprint of the system 100. In addition, the housing 146, water tank 143 and reclaim tank 147 may be configured as a “floating water” system. Specifically, the portion of piping or tubing 142 inside the housing 146 along with other components like valves (not shown) and pumps (not shown) may be disposed along a side of the housing 146 or in any other suitable manner such that housing 146 can be moved from one location to another without having to reconnect the feed system 141 and the piping to the drains of the agricultural facility when the housing 146 is moved from one location to another. In addition, the water tank 143 and the reclaim tank 147 may each comprise one or more built-in coolers (not shown) for regulating the temperature of the water and/or nutrient solution.

In various embodiments, the ventilation system 160 may comprise a duct system 162 for removing stale, warm and moist air from the first and second plurality of incubation chambers 126a, 126b and replacing it with clean air from an air source (not shown) so that the plants contained inside the first and second plurality of incubation chambers 126a, 126b may receive a sufficient flow of clean air, which in turn may result in a higher quality and faster plant growth. In addition, the ventilation system 160 may comprise an intake fan (not shown) or any other suitable apparatus for drawing air into the controlled environment, one or more filters for conditioning air drawn therethrough, and an exhaust fan (not shown) for venting air through the filters for removing odors before venting the resulting clean air out of the agricultural facility. The one or more filters may be substantially enclosed or configured to prevent contaminants from infecting the plants and/or spreading within the controlled environment.

The duct assembly 162 may be detachably coupled to the first plurality of incubation chambers 124a and the second plurality of incubation chambers 124b. In one embodiment, the duct assembly 162 may be directly routed to a plurality of apertures (not shown) positioned at various locations around each incubation chamber 124a, 124b, such that each incubation chamber 124a, 12b may diffuse the air throughout each incubation chamber 124a, 124b. Diffusing the air throughout each incubation chamber 124a, 124b ensures that the air is fully replenished and displaced so that the air does not stagnate between the plants. In addition, diffusing the air in this manner ensures that the ventilated air is not short cycling to the relief system, thereby reducing waste and inefficiency.

The controller 180 may be configured to the specific needs of the operator and may integrate various components of the system 100, monitor, and controllably operate lighting, airflow, mixing, feeding, drainage, recycling, temperature, and humidity within the controlled environment in order to optimize the development cycle of growth desired. The controller 180 may be linked to a remote control interface allowing an operator to adjust and customize various irrigation parameters of the feed system 141, including flow rates and nutrient concentrations, from a remote location using the controller.

According to various embodiments, the controller 180 may comprise a state machine (not shown), which may be configured to receive inputs from various components of the system 100 and provide a plurality of control signals, i.e., enable and disable signals, to various components of the system 100, such as the light source, and to various pumps, fans, and sensors, such as growth sensors, environmental sensors, and nutrient sensors. Additionally, the controller 180 may utilize artificial intelligence algorithms to analyze data from various sensors and optimize plant growth conditions dynamically based on changing environmental factors and plant growth stages. The controller 180, including the functionality of the state machine, may be implemented using a variety of different logic components, processors, associated configuration data and/or stored programming instructions.

In operation, a method for optimizing plant growth may comprise utilizing the controller 180 to controllably operate various components of the system 100. Performing the method may comprise performing various treatment processes as described below. In addition, performing the method may comprise utilizing the controller 180 to read information from the growth sensor to determine if growth has occurred and compute the amount of water and/or nutrient solution to be delivered in each feeding cycle, control the reclaim process of any drainage from overwatering or overfeeding, and alter the atmospheric conditions and temperature within the controlled environment. In addition, the controller 180 may compute the total number of on/off light cycles and control the intensity and/or duration of the growth inducing light source for each on/off cycle according to said computations. For example, the controller 180 may controllably operate the growth inducing light source to increase its intensity and/or output over a first predetermined time period and subsequently decrease its intensity and/or output over a second predetermined time period in order to mimic natural sunlight.

The method may further comprise treating the plants with any suitable reactive atomized hydrogen peroxide or composition comprising a reactive oxygen species that is safe for human consumption and that prevents or minimizes the risk of contaminants like viruses, bacteria, or fungi from infecting the plants and/or spreading within the controlled environment. For example, the composition may comprise peracetic acid, hydroperoxide, peroxide, potassium percarbonate, ozone hydroxyl radicals, trioxidane or any combination thereof. For example, in one embodiment, the concentration of hydrogen peroxide may be approximately 0.05%, 0.1%, 0.2%, 0.3%, 0.4%, 0.5%, 1%, 1.5%, 2%, 2.5% and 3% by weight of the mixture. It will be appreciated that any suitable dilutant, such as potable water, including reverse osmosis water, may be used as a dilutant. The method may also comprise utilizing a UV light source (not shown) to treat the plants, thereby further protecting the plants against contaminants.

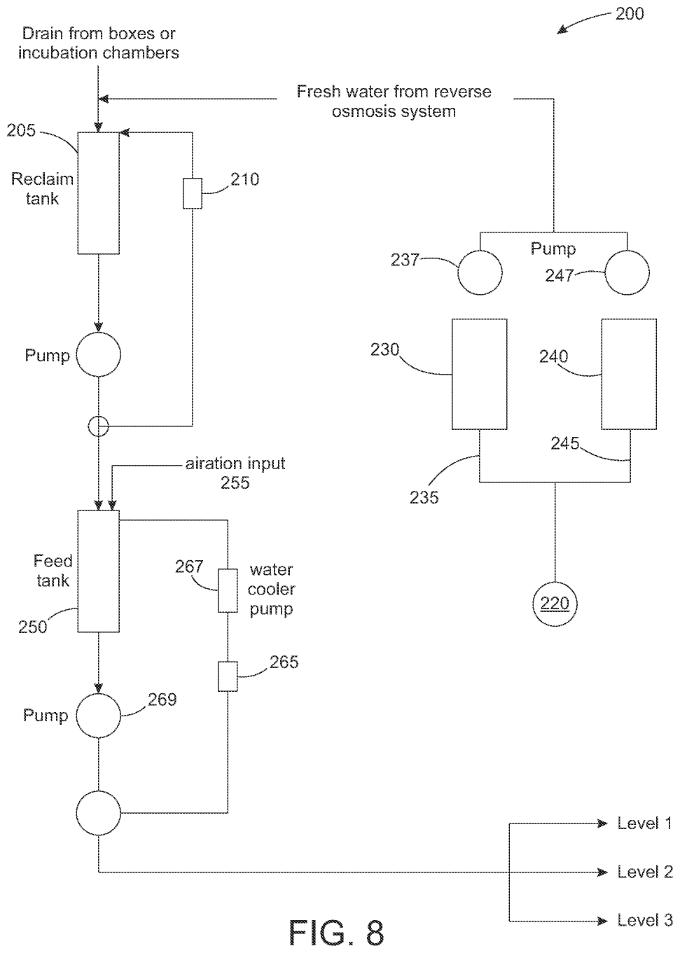

Additionally, and referring now to FIG. 8, the method for optimizing plant growth may comprise utilizing a water management system 200 to ensure the consistency and quality of the water supply within the controlled environment. The water management system 200 may comprise several phases.

Firstly, any surplus water or nutrient solution, referred to as drainage, may undergo a treatment process to eliminate impurities and remove contaminants. A reclaim tank 205 may receive excess water or nutrient solution drained from the incubation chambers (126a, 126b), as described in paragraphs to of the instant specification. During the first phase, a UV light source 210 may be utilized to effectively eradicate any contaminants, rendering the reclaimed drainage suitable for reuse. Concurrently, a dedicated main unit 220 may operate a reverse osmosis (RO) system or osmosic purification process, which may be used to remove any additional contaminants or undesired substances from water.

Following the reverse osmosis purification process, the resulting fresh water may be transported to a first atmospheric tank 230 and a second atmospheric tank 240 through a controlled system comprising a first valve 235, a second valve 245, and a first pump 237, and a second pump 247. The first valve 235 and second valve 245 may be utilized to regulate flow and sustain optimal pressure within the first pump 237 and second pump 247, respectively. The atmospheric tanks 230, 240 may serve as reservoirs for preserving the fresh water, ensuring a steady supply of high-quality water.

When the treated water is ready to be reused, the first pump 237 and second pump 247, which may be connected to the first atmospheric tank 230 and second atmospheric tank 240, respectively, may pump the freshly purified reverse osmosis water to introduce the purified reverse osmosis water into the previously treated reclaimed drainage, initiating the reclamation cycle.

The amalgamated water, stemming from a blend of fresh reverse osmosis water and reclaimed drainage, may be subsequently directed to a feed tank 250. Within the feed tank 250, one or more aeration inputs 255, such as oxygen, may be introduced to further enhance water quality, prevent stagnation, promote nutrient absorption, and maintain pH levels. The water may then be channeled through a systematic process 260 involving treatment with an additional UV light source 265 and cooling via a water cooler loop 267 to ensure that the water is optimized for plant cultivation, free from contaminants and is at an ideal temperature. Lastly, the treated and conditioned water may be pumped from the feed tank 250 via a pump 269 directly to the plants.

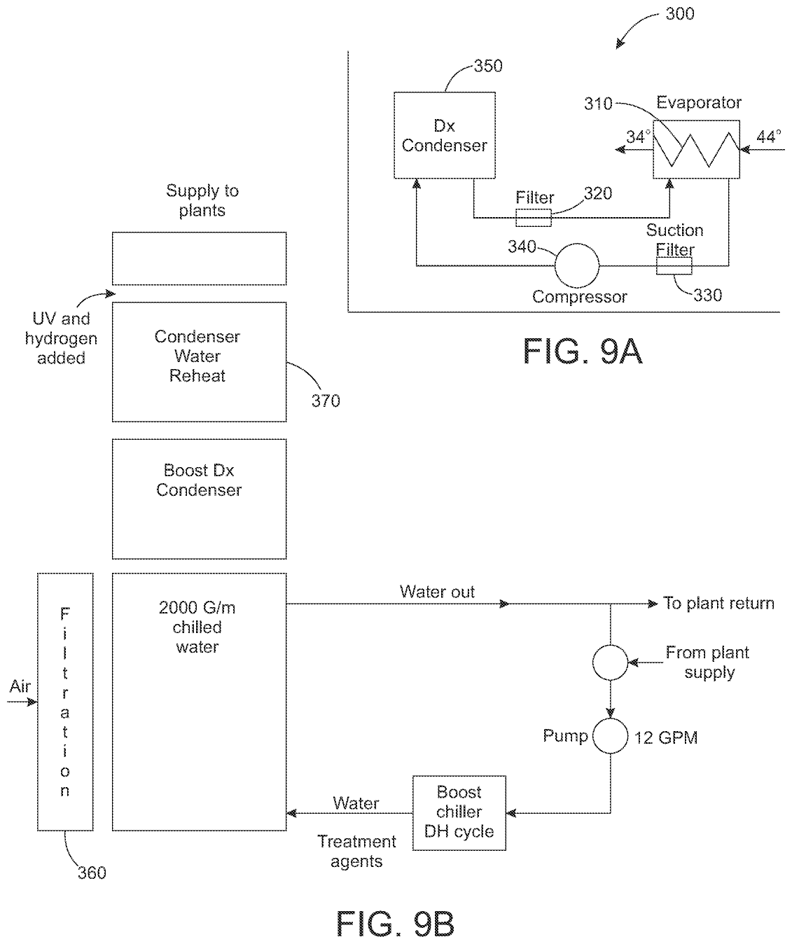

Additionally, in certain embodiments, a temperature regulation sub-system of the drainage management system may be utilized to maintain the temperature of the water or nutrient solution within a specified range to optimize plant growth. For example, the water may be further treated with a treatment process known as a “chiller DH cycle” 300 to ensure optimal conditions for plant growth. Initially, and referring now to FIGS. 9A and 9B, the water may be conveyed through an evaporator 310 and a filter 320 to remove impurities. Subsequently, the water passes through a suction filter 330 to further enhance its quality. The next critical phase involves a compressor 340, where the water undergoes pressurization, an essential step in the cooling process.

Following compression, the water may be treated with one or more treatment agents to enhance its suitability for plant cultivation. Once the water is treated, the water may be directed to a DX condenser 350. At the DX condenser 350, aeration inputs 360 may be introduced into the water to improve the water's oxygenation.

After the water has been oxygenated, it may then be sent to a reheat unit 370, where it is reheated to a desired temperature. Lastly, the conditioned and treated water may be distributed to the plants within the controlled environment.

In the foregoing specification, the technology has been described with reference to specific exemplary embodiments. Appendix A has been incorporated herein by reference. Various modifications and changes may be made, however, without departing from the scope of the present technology as set forth in the claims. The specification and figures are illustrative, rather than restrictive, and modifications are intended to be included within the scope of the present technology. Accordingly, the scope of the technology should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims. Benefits, other advantages, and solutions to problems have been described above with regard to particular embodiments; however, any benefit, advantage, solution to problem or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, methods, processes, or components used in the practice of the present invention, in addition to those not specifically recited, may be varied, or otherwise particularly adapted to specific environments, manufacturing specifications, design parameters or other operating requirements without departing from the general principles of the same.

1. An integrated plant cultivation system for use in a controlled environment or agricultural facility having a growth inducing light source, comprising:
a rack assembly adaptable for multiple levels of plant cultivation;
a plurality of boxes configured for holding plants, the boxes arranged on each level of the rack assembly, wherein each box comprises a plurality of incubation chambers for plant growth;
an irrigation system connected to the plurality of incubation chambers via a feed system, wherein the irrigation system is configured to supply water or a nutrient solution to the incubation chambers, and wherein each chamber is configured to receive a customized nutrition scheme;
a drainage management system for reclaiming excess water or nutrient solution and recycling the drainage for sustained system use;
a ventilation system for maintaining optimal atmospheric conditions within the plurality of incubation chambers; and
a controller for controlling the growth-inducing light source and regulating environmental conditions within each incubation chamber to optimize plant development according to growth stages of the plants.

2. The integrated plant cultivation system of claim 1, wherein each box is stackable and interconnectable to form levels of the rack assembly.

3. The integrated plant cultivation system of claim 1, wherein each incubation chamber comprises a sensor configured to monitor the environmental conditions and provide real-time data to the controller for regulation of growth of the plants.

4. The integrated plant cultivation system of claim 3, wherein the irrigation system is linked to the controller to allow for remote adjustment of the water or nutrient supply to the incubation chamber based on data received from the sensor.

5. The integrated plant cultivation system of claim 1, wherein the feed system is independently routed to each incubation chamber to provide the customized nutrition scheme for each chamber.

6. The integrated plant cultivation system of claim 1, wherein the controller utilizes artificial intelligence algorithms to analyze data from various sensors and optimize plant growth conditions dynamically based on changing environmental factors and plant growth stages.

7. The integrated plant cultivation system of claim 1, wherein the ventilation system comprises a duct assembly, and wherein the duct assembly is configured to facilitate uniform air distribution within each incubation chamber.

8. The integrated plant cultivation system of claim 1, wherein the drainage management system comprises a water or nutrient tank, and wherein the water or nutrient tank comprises a temperature regulation sub-system to maintain the temperature of the water or nutrient solution within a specified range to optimize plant growth.

9. The integrated plant cultivation system of claim 1, wherein the drainage management system further comprises a reclaim tank, wherein the reclaim tank is connected with the water or nutrient tank, and wherein the reclaim tank receives excess water or nutrient solution drained from the incubation chambers, and the water or nutrient tank replenishes the reclaim tank with fresh water or nutrient solution, thereby establishing a closed-loop system for efficient utilization and recycling of water and nutrients.

10. The integrated plant cultivation system of claim 1, wherein the feed system comprises: piping or tubing coupled to a plurality of feedwater diffuser heads positioned above the incubation chambers for effectively dispersing a controlled amount of the water or nutrient solution over the plants.

11. A method for optimizing plant growth in an integrated plant cultivation system as described in claim 1, comprising:
utilizing a controller to controllably operate various components of the system;
reading information from a growth sensor to determine if growth has occurred;
computing an amount of water or nutrient solution to be delivered in a feeding cycle based on the growth sensor data;
controlling the reclaim process of any drainage resulting from overwatering or overfeeding;
altering the atmospheric conditions and temperature within the controlled environment to optimize plant growth;
computing a total number of on/off light cycles and controlling the intensity or duration of the growth-inducing light source for each on/off cycle based on the computations; and
controllably operating the growth-inducing light source to adjust its intensity or output over a first predetermined time period and subsequently decrease its intensity or output over a second predetermined time period to mimic natural sunlight.

12. The method of claim 11, further comprising the step of treating the plants with a composition comprising a reactive oxygen species to prevent or minimize the risk of contaminants from infecting the plants or spreading within the controlled environment.

13. The method of claim 12, wherein the composition used for treating the plants comprises peracetic acid, hydrogen peroxide, hydroperoxide, potassium percarbonate, ozone, hydroxyl radicals, trioxidane, or a combination thereof.

14. The method of claim 13, wherein the concentration of hydrogen peroxide in the composition is selected from the range of approximately 0.05% to 3% by weight of the composition.

15. The method of claim 14, wherein a dilutant is used to dilute the composition prior to treating the plants with the composition.

16. The method of claim 15, wherein the dilutant is potable water or reverse osmosis water.

17. The method of claim 16, further comprising utilizing a UV light source to treat the plants to provide an additional layer of protection against contaminants.
